(19) United States
(12) Patent Application Publication
(10) Pub. No.: US 2022/0243781 A1
(43) Pub. Date: Aug. 4, 2022

(54) ACCUMULATOR FOR A DAMPER AND METHOD OF MANUFACTURE THEREOF

(71) Applicant: DRiV Automotive Inc., Lake Forest, IL (US)

(72) Inventor: Stefan Deferme, Heusden-Zolder (BE)

(21) Appl. No.: 17/166,425

(22) Filed: Feb. 3, 2021

(51) Int. Cl. F16F 9/096; F16F 9/06; F16F 9/32; F16F 9/36; F16F 9/43

(52) U.S. Cl. CPC F16F 9/096; B60G 13/08; F16F 9/061; F16F 9/3207; F16F 9/361; F16F 9/3271; F16F 9/43; F16F 2224/0208; F16F 2224/02; F16F 2232/08; F16F 2234/02; F16F 2230/30; F16F 2222/12; F16F 9/067; F16F 2226/04; F16F 2230/06; F16F 9/065

(57) ABSTRACT

An accumulator for a damper is provided. The accumulator includes a housing defining a longitudinal axis, a fluid connector and a bag. The bag includes a plurality of annular discs disposed adjacent to each other. Each annular disc includes an inner diameter defining a through aperture and an outer diameter. The plurality of annular discs includes a first end disc, a second end disc and one or more intermediate discs. Each intermediate disc is disposed between two adjacent annular discs. The inner diameter of the first end disc is connected to the fluid connector. The inner diameter of each intermediate disc is connected to the inner diameter of one adjacent annular disc. The outer diameter of each intermediate disc is connected to the outer diameter of the other adjacent annular disc. A solid cover disc is connected to the outer diameter of the second end disc.

### TECHNICAL FIELD

The present disclosure relates to an accumulator, and in particular to an accumulator for a damper and a method of manufacturing the accumulator.

### BACKGROUND

A damper includes a piston and a piston rod received within a chamber. A volume of the piston rod is generally compensated by using an accumulator. Conventional accumulators are of different types. For example, piston accumulators include a piston in a cylindrical accumulator vessel for separating a hydraulic fluid from a gas. The gas is compressed to store energy from the hydraulic fluid flowing into the vessel. Metal bellow accumulators include a metal bellows to separate the hydraulic fluid from the gas. Gas bag accumulators use a bag to separate the hydraulic fluid from the gas, while diaphragm accumulators use a diaphragm to separate the hydraulic fluid from the gas.

Piston accumulators typically have high internal friction. Diaphragm accumulators may not have adequate performance over a long period. Metal bellows accumulators may involve high weight and cost. Existing gas bag accumulators may have limited design variants. Further, the challenge with gas bags is that there are chances of folding lines which may deteriorate a bag material and can lead to leakage between a gas side and a hydraulic fluid side. Therefore, there exists a need for an accumulator that can overcome the aforementioned drawbacks of conventional accumulator designs.

### SUMMARY

According to a first aspect there is provided an accumulator for a damper. The accumulator includes a housing, a fluid connector and a bag. The housing defines a longitudinal axis. The fluid connector is at least partially received within the housing. The bag includes a plurality of annular discs received within the housing and disposed adjacent to each other along the longitudinal axis of the housing. Each annular disc includes an inner diameter defining a through aperture and an outer diameter. The plurality of annular discs includes a first end disc disposed adjacent to the fluid connector, a second end disc disposed distal to the fluid connector and one or more intermediate discs. Each intermediate disc is disposed between two adjacent annular discs. The inner diameter of the first end disc is connected to the fluid connector. The inner diameter of each intermediate disc is connected to the inner diameter of one adjacent annular disc. The outer diameter of each intermediate disc is connected to the outer diameter of the other adjacent annular disc. The bag further includes a cover disc connected to the outer diameter of the second end disc. The cover disc is a solid disc without any apertures. The plurality of discs and the cover disc define a first volume therebetween. The connector fluidly communicates the first volume with a chamber of the damper. The housing defines a second volume surrounding the bag.

In another aspect of the disclosure, a damper is provided. The damper includes a tube and an accumulator. The tube defines a chamber therein and the chamber receives a hydraulic fluid therein. The accumulator includes a housing, a fluid connector and a bag. The housing defines a longitudinal axis. The fluid connector is at least partially received within the housing. The bag includes a plurality of annular discs received within the housing and disposed adjacent to each other along the longitudinal axis of the housing. Each annular disc includes an inner diameter defining a through aperture and an outer diameter. The plurality of annular discs includes a first end disc disposed adjacent to the fluid connector, a second end disc disposed distal to the fluid connector and one or more intermediate discs. Each intermediate disc is disposed between two adjacent annular discs. The inner diameter of the first end disc is connected to the fluid connector. The inner diameter of each intermediate disc is connected to the inner diameter of one adjacent annular disc. The outer diameter of each intermediate disc is connected to the outer diameter of the other adjacent annular disc. The bag further includes a cover disc connected to the outer diameter of the second end disc. The cover disc is a solid disc without any apertures. The plurality of discs and the cover disc define a first volume therebetween. The connector fluidly communicates the first volume with the chamber of the damper such that the first volume receives the hydraulic fluid therein. The housing defines a second volume surrounding the bag and receiving a gas therein. The first volume is configured to change based on a direction of flow of the hydraulic fluid between the chamber of the damper and the first volume.

In yet another aspect of the disclosure, a method of manufacturing an accumulator is provided. The method includes providing a housing defining a longitudinal axis and receiving a fluid connector at least partially within the housing. The method further includes receiving a plurality of annular discs within the housing and disposed adjacent to each other along the longitudinal axis of the housing. Each annular disc includes an inner diameter defining a through aperture and an outer diameter. The plurality of annular discs includes a first end disc disposed adjacent to the fluid connector, a second end disc disposed distal to the fluid connector and one or more intermediate discs. Each intermediate disc is disposed between two adjacent annular discs. The method further includes connecting an inner diameter of the first end disc to the fluid connector. The method further includes connecting the inner diameter of each intermediate disc to the inner diameter of one adjacent annular disc. The method further includes connecting the outer diameter of each intermediate disc to the outer diameter of the other adjacent annular disc. The method further includes connecting the outer diameter of the second end disc to a cover disc. The cover disc is a solid disc without any apertures.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF DRAWINGS

FIG. 1 is an illustration of a vehicle incorporating a suspension system, according to an aspect of the present disclosure;

FIG. 2 is a schematic illustration of a damper associated with the suspension system of FIG. 1, according to an aspect of the present disclosure;

FIG. 3 is a sectional view of an accumulator of the damper of FIG. 2, according to an aspect of the present disclosure;

FIG. 4 is a top view of an annular disc of the accumulator of FIG. 3;

FIG. 5 is a top view of a cover disc of the accumulator of FIG. 3;

FIG. 6 is a sectional view of the accumulator prior to assembly with the damper of FIG. 2;

FIG. 7 shows a partial sectional view of an annular disc of the accumulator of FIG. 3; and

FIG. 8 shows a method of manufacturing the accumulator of FIG. 3.

### DETAILED DESCRIPTION

Wherever possible, the same reference numbers will be used throughout the drawings to refer to same or like parts.

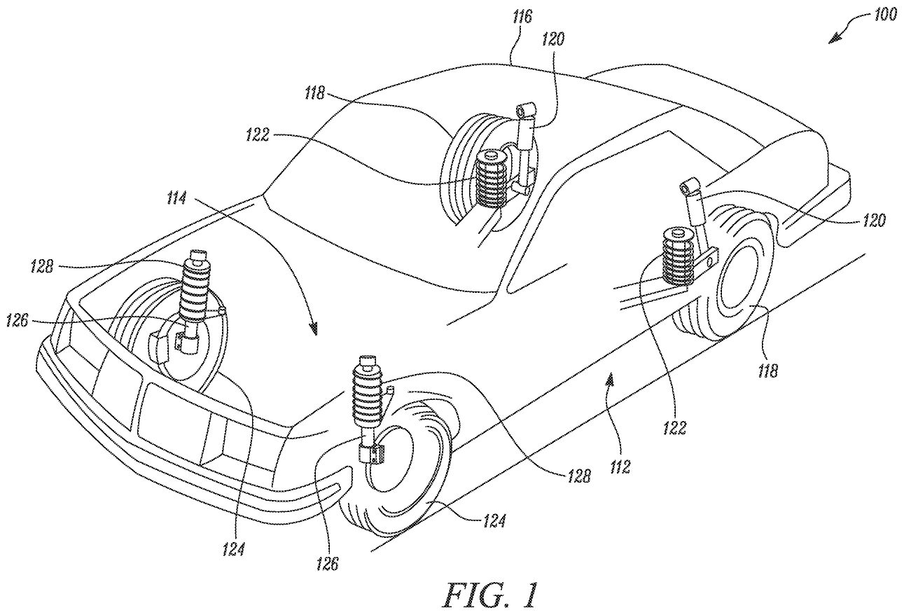

The following description is merely exemplary in nature and is not intended to limit the present disclosure, application, or uses. There is shown in FIG. 1, a vehicle incorporating a suspension system in accordance with the present disclosure and which is designated generally by the reference numeral 100. Vehicle 100 includes a rear suspension 112, a front suspension 114 and a body 116. Rear suspension 112 has a transversely extending rear axle assembly (not shown) adapted to operatively support a pair of rear wheels 118. The rear axle is attached to body 116 by means of a pair of dampers 120 and by a pair of springs 122. Similarly, front suspension 114 includes a transversely extending front axle assembly (not shown) to operatively support a pair of front wheels 124. The front axle assembly is attached to body 116 by means of a pair of dampers 126 and by a pair of springs 128. The dampers 120 and 126 serve to dampen the relative motion of the unsprung portion (i.e., the front and rear suspensions 112, 114) with respect to the sprung portion (i.e., the body 116) of the vehicle 100. Sensors (not shown), at each wheel 118 and each wheel 124, sense the position and/or the velocity and/or the acceleration of the body 116 in relation to the rear suspension 112 and the front suspension 114. While the vehicle 100 has been depicted as a passenger car having front and rear axle assemblies, the dampers 120 and 126 may be used with other types of vehicles or in other types of applications including, but not limited to, vehicles incorporating non-independent front and/or non-independent rear suspensions, vehicles incorporating independent front and/or independent rear suspensions or other suspension systems known in the art. Further, the term “damper” as used herein is meant to refer to shock absorbers and hydraulic dampers in general and thus will include McPherson struts and other hydraulic damper designs known in the art.

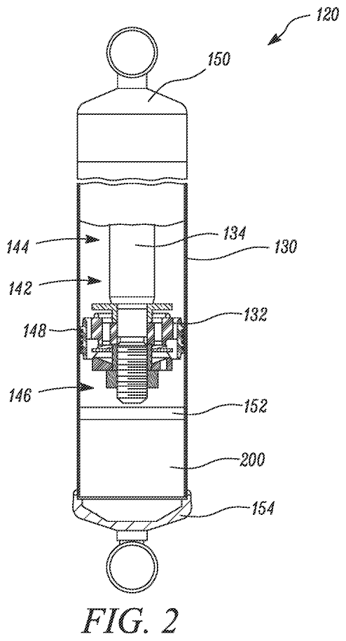

Referring to FIG. 2, one of the dampers 120 is illustrated schematically. While FIG. 2 only illustrates the damper 120, the dampers 126 include the same components discussed below for the damper 120. The only difference between the dampers 120 and 126 may be the way in which the damper is attached to the sprung and/or unsprung portion of the vehicle 100 (shown in FIG. 1).

As shown in FIG. 2, the damper 120 is a mono-tube damper including a pressure tube 130, a piston assembly 132 and a piston rod 134. However, in alternative embodiments, the damper 120 may be a dual tube or a triple tube damper. The pressure tube 130 defines a fluid chamber 142. The fluid chamber 142 receives a hydraulic fluid therein. The piston assembly 132 is slidably disposed within the pressure tube 130 and divides the fluid chamber 142 into an upper working chamber 144 and a lower working chamber 146. A seal 148 is disposed between the piston assembly 132 and the pressure tube 130 to permit sliding movement of the piston assembly 132 with respect to the pressure tube 130 without generating undue frictional forces as well as sealing the upper working chamber 144 from the lower working chamber 146. The piston rod 134 is attached to the piston assembly 132 and extends through upper working chamber 144 and through an upper end cap 150 which closes the upper end of the pressure tube 130. A sealing system (not shown) seals the interface between the upper end cap 150, the pressure tube 130 and the piston rod 134. An end of the piston rod 134 opposite to the piston assembly 132 is adapted to be secured to one end of the sprung and unsprung mass of vehicle 100. A valving within the piston assembly 132 controls the movement of the hydraulic fluid between the upper working chamber 144 and the lower working chamber 146 during movement of the piston assembly 132 within the pressure tube 130. As the piston rod 134 extends only through the upper working chamber 144 and not the lower working chamber 146, movement of the piston assembly 132 with respect to the pressure tube 130 causes a difference in the amount of the hydraulic fluid displaced in the upper working chamber 144 and the amount of the hydraulic fluid displaced in the lower working chamber 146. The difference in the amount of fluid displaced is known as the “rod volume” and it is accommodated for by the use of a floating piston 152 as is well known in the art. The floating piston 152 separates the fluid chamber 142 from an accumulator 200. Depending on the type of damper (monotube or dual tube or triple tube), the accumulator 200 may be located adjacent to the floating piston 152 or at a location surrounding the pressure tube 130 or remote from the pressure tube 130. The accumulator 200 may be in fluid communication with the fluid chamber 142 by valves and hydraulic lines. A lower end cap 154 seals the end of the pressure tube 130. The lower end cap 154 is adapted to be secured to the other end of the sprung and unsprung mass of vehicle 100.

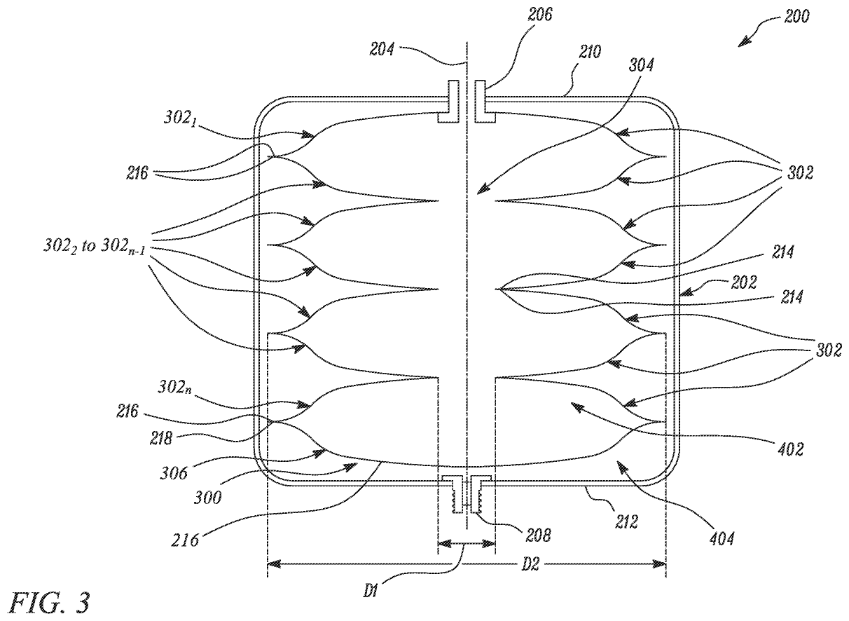

FIG. 3 shows a sectional view of the accumulator 200 in a working or an active condition after the accumulator 200 is installed in the damper 120. The accumulator 200 includes a housing 202, a fluid connector 206 and a bag 300. The housing 202 defines a longitudinal axis 204. The fluid connector 206 is at least partially received within the housing 202. The housing 202 receives the fluid connector 206 at least partially through a wall 210 of the housing. The housing 202 is made of a metallic material, for example, aluminum or alloys thereof. The fluid connector 206 may be any suitable fluid connector as per application requirements.

The bag 300 includes a plurality of annular discs 302 received within the housing 202. The plurality of annular discs 302 are disposed adjacent to each other along the longitudinal axis 204 of the housing 202. Each annular disc 302 includes an inner diameter 214 defining a through aperture 304 and an outer diameter 216. The bag 300 further includes a cover disc 306.

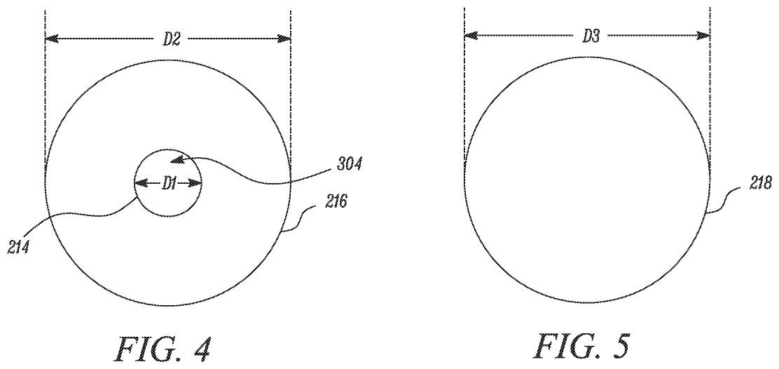

A top view of one of the annular discs 302 is shown in FIG. 4. The inner diameter 214 of each annular disc 302 defines an inner diameter value D1. Further, the outer diameter 216 of each annular disc 302 defines an outer diameter value D2. The inner diameter 214 includes an annular region defining the through aperture 304. The through aperture 304 has a circular shape. However, in other embodiments, through aperture 304 may have a non-circular shape, such as elliptical, polygonal and oval. The outer diameter 216 includes an annular region extending from a circumference of each annular disc 302.

A top view of the cover disc 306 is shown in FIG. 5. The cover disc 306 is a solid disc without any apertures or openings. The diameter 218 of the cover disc 306 defines a diameter value D3. The diameter 218 includes an annular region extending from a circumference of the cover disc 306.

Referring back to FIG. 3, the plurality of annular discs 302 includes a first end disc 302₁, a second end disc 302ₙ and one or more intermediate discs 302₂ to 302ₙ₋₁. The first end disc 302₁ is disposed adjacent to the fluid connector 206. The second end disc 302ₙ is disposed distal to the fluid connector 206. Each intermediate disc 302₂ to 302ₙ₋₁ is disposed between two adjacent annular discs 302. Specifically, each intermediate disc 302₂ to 302ₙ₋₁ is axially disposed between two adjacent annular discs 302 relative to the longitudinal axis 204. For example, the intermediate disc 302₂ is disposed between the first end disc 302₁ and the intermediate disc 3023. The intermediate disc 302ₙ₋₁ is disposed between the intermediate disc 302ₙ₋₂ and the second end disc 302₁. In general, the intermediate disc 302ᵢ (1<i<n) is disposed between the annular disc 302ᵢ₋₁ and the annular disc 302ᵢ₊₁. Further, the one or more intermediate discs 302₂ to 302ₙ₋₁ are together axially disposed between the first end disc 302₁ and the second end disc 302₇ relative to the longitudinal axis 204.

In the illustrated embodiments, the bag 300 includes seven annular discs 302 (i.e., n=7). Therefore, the annular disc 302₇ is the second end disc. The intermediate discs 302₂ to 302₆ are together disposed between the annular discs 302₁ and 302₇.

As shown in FIG. 3, the inner diameter 214 of the first end disc 302₁ is connected to the fluid connector 206. The inner diameter 214 of each intermediate disc 302₂ to 302ₙ₋₁ is connected to the inner diameter 214 of one adjacent annular disc 302. Further, the outer diameter 216 of each intermediate disc 302₂ to 302ₙ₋₁ is connected to the outer diameter 216 of the other adjacent annular disc 302. In some embodiments, each intermediate disc 302₂ to 302ₙ₋₁ is connected to the adjacent annular discs 302 by thermal sealing. In some embodiments, each intermediate disc 302₂ to 302ₙ₋₁ is connected to the adjacent annular discs 302 by induction heated thermal sealing.

In general, the outer diameter 216 of the intermediate disc 302ⱼ (j is an even number less than n) is connected to the outer diameter 216 of the annular disc 302ⱼ₋₁. Further, the inner diameter 214 of the intermediate disc 302ⱼ (2≤j is an even number less than n) is connected to the inner diameter 214 of the annular disc 302ⱼ₊₁. For example, the outer diameter 216 of the intermediate disc 302₄ is connected to the outer diameter 216 of the intermediate disc 302₃. The inner diameter 214 of the intermediate disc 302₄ is connected to the inner diameter 214 of the intermediate disc 302₅.

In general, the outer diameter 216 of the intermediate disc 302ₖ (k is an odd number greater than 1 and less than n) is connected to the outer diameter 216 of the annular disc 302ₖ₊₁. Further, the inner diameter 214 of the intermediate disc 302ₖ (k is an odd number greater than 1 and less than n) is connected to the inner diameter 214 of the annular disc 302ₖ₋₁. For example, the outer diameter 216 of the intermediate disc 302₃ is connected to the outer diameter 216 of the intermediate disc 302₄. The inner diameter 214 of the intermediate disc 302₃ is connected to the inner diameter 214 of the intermediate disc 302₂.

The bag 300 further includes a cover disc 306. The cover disc has a diameter 218. The cover disc 306 is a solid disc without any apertures or openings. The diameter 218 of the cover disc 306 is connected to the outer diameter 216 of the second end disc 302ₙ. In some embodiments, the cover disc 306 is connected to the second end disc 302ₙ by thermal sealing. In some embodiments, the cover disc 306 is connected to the second end disc 302ₙ by induction heated thermal sealing.

The plurality of annular discs 302 and the cover disc 306 define a first volume 402 therebetween. The fluid connector 206 fluidly communicates the first volume 402 with a chamber of the damper 120 (shown in FIG. 2) such that the first volume 402 receives the hydraulic fluid therein. The hydraulic fluid may be an oil. Specifically, the fluid connector 206 fluidly communicates the first volume 402 with the lower working chamber 146 of the damper 120. The housing 202 further defines a second volume 404 surrounding the bag 300. The first volume 402 is sealed from the second volume 404. The second volume 404 is configured to receive a gas therein. The first volume 402 is configured to change based on a direction of flow of the hydraulic fluid between the first volume 402 and the lower working chamber 146 of the damper 120. Therefore, the bag 300 contracts or expands axially in the direction of the longitudinal axis 204 depending on whether the hydraulic fluid flows out of the first volume 402 or the hydraulic fluid flows into the first volume 402. Specifically, the bag 300 may contract when the damper 120 extracts the hydraulic fluid from the first volume 402. Further, the bag 300 may contract when the damper 120 pushes the hydraulic fluid into the first volume 402. A pressure of the gas may affect a static pressure of the hydraulic fluid inside the damper 120. The static pressure may affect functioning of one or more valves of the damper 120.

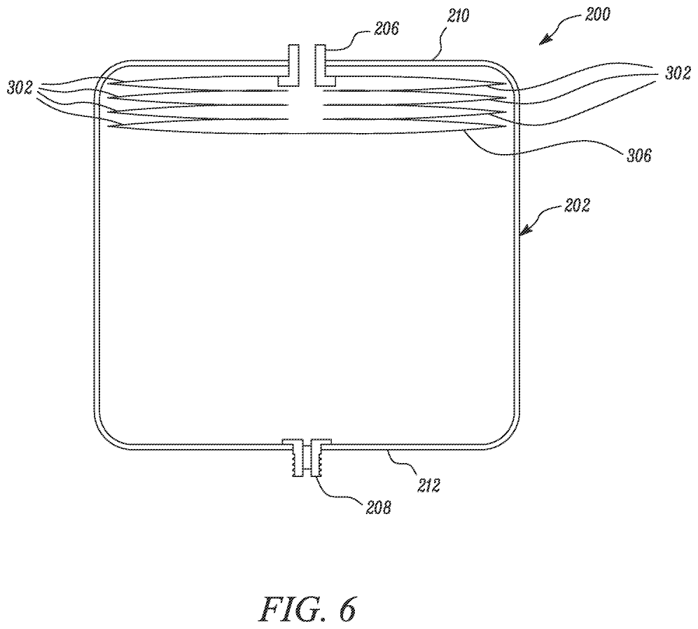

FIG. 6 shows the accumulator 200 in a pre-charged condition prior to its assembly with the pressure tube 130 of the damper 120. The figure illustrates a collapsed state of the bag 300. In the collapsed state of the bag 300, the first volume 402 (shown in FIG. 3) has a minimum value (e.g., near to zero) and the second volume 402 has a maximum value due to absence of the hydraulic fluid inside the plurality of annular discs 302 and the cover disc 306. As the hydraulic fluid is received in the bag 300 from the lower working chamber 146 of the damper 120 via the fluid connector 206, the bag 300 expands axially in the direction of longitudinal axis 204. In the expansion process of the bag 300, the first volume 402 increases and the second volume 404 decreases.

Referring to FIG. 6, the accumulator 200 optionally includes a gas filling connection 208. The gas filling connection 208 is provided on a wall 212 located opposite to the wall 210 which receives the fluid connector 206. The gas filling connection 208 is used to fill the gas inside the second volume 404 surrounding the bag 300 within the housing 202. The gas may be compressed nitrogen, carbon dioxide or even a liquified gas. Furthermore, the second volume 404 is configured to change based on the change in the first volume 402. The gas filling connection 208 may seal the second volume 404 after filling of the gas.

The housing 202 is illustrated as rectangular with rounded edges. However, the housing 202 may have any suitable shape as per application requirements, such as circular, elliptical, polygonal, etc. The relative positioning of the fluid connector 206 and the gas filling connection 208 may also be varied.

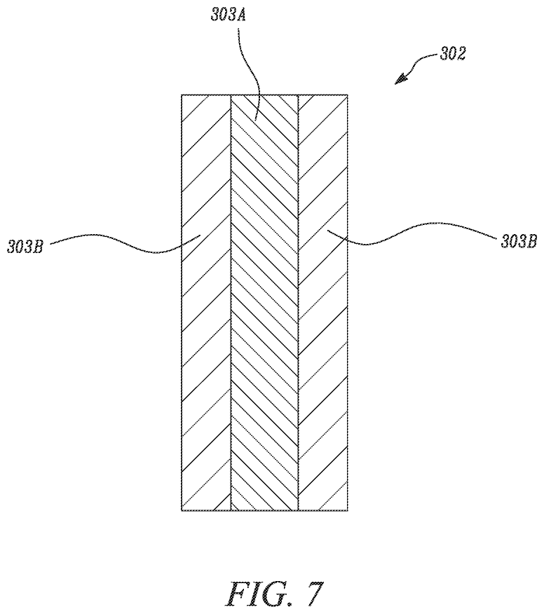

FIG. 7 illustrates a partial sectional view of one of the annular discs 302. Each annular disc 302 includes a plurality of layers. The plurality of layers includes at least one metallic layer 303A and at least one polymeric layer 303B. The at least one metallic layer 303A is disposed between two polymeric layers 303B. As shown in FIG. 7, each annular disc 302 includes a metallic layer 303A sandwiched between two polymeric layers 303B. The metallic layer 303A may be made of aluminum or alloys thereof. In some embodiments, the metallic layer 303A may include rolled aluminum. Each of polymeric layers 303B may be made of a polymeric material, for example, polyamide, polyethylene terephthalate, etc. The presence of the polymeric layers 303B may provide stability, increase a tear strength and reduce creasing. The configuration of the cover disc 306 is also similar to that of each annular disc 302. The cover disc 306 includes a plurality of layers. The plurality of layers of the cover disc 306 includes at least one metallic layer 303A and at least one polymeric layer 303B. Specifically, the cover disc 306 includes the metallic layer 303A sandwiched between the two polymeric layers 303B.

Furthermore, in an example, each of the cover disc 306 and the first end disc 302₁ may be made of a material that is different from that of the material of each annular disc 302. In some embodiments, each of the cover disc 306 and the first end disc 302₁ may include a thicker polyamide disc with higher amount of stiffness and robustness as compared to the material of each annular disc 302.

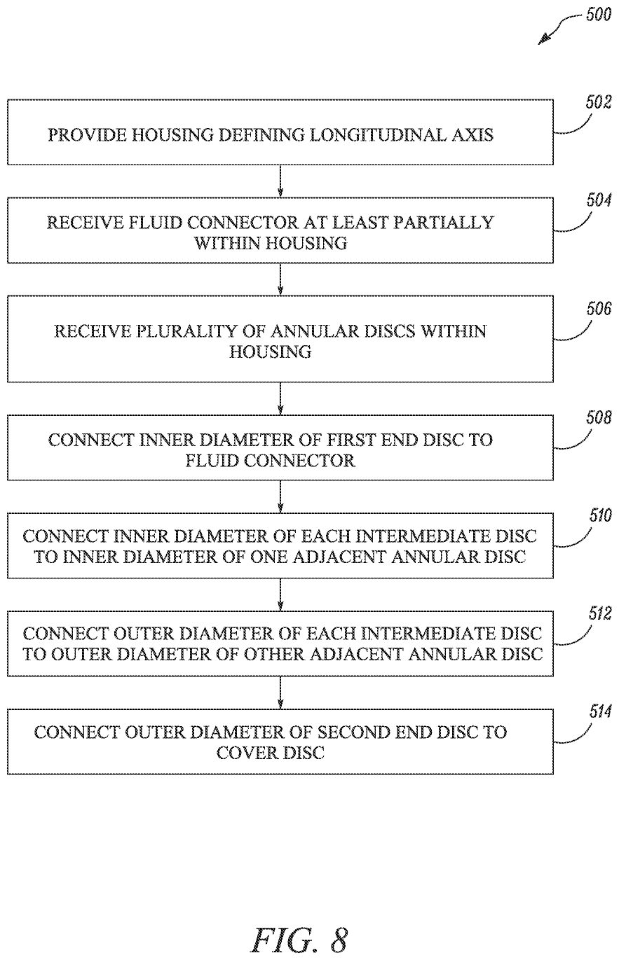

FIG. 8 illustrates a method 500 of manufacturing the accumulator 200. At step 502, the method 500 includes providing the housing 502 defining the longitudinal axis 204. At step 504, the method 500 includes receiving the fluid connector 206 at least partially within the housing 202.

At step 506, the method 500 includes receiving the plurality of annular discs 302 within the housing 202. The plurality of annular discs 302 are disposed adjacent to each other along the longitudinal axis 204 of the housing 202. Each annular disc 302 includes the inner diameter 214 defining the through aperture 304 and the outer diameter 216. The plurality of annular discs 302 includes the first end disc 302₁, one or more intermediate discs 302₂ to 302ₙ₋₁ and the second end disc 302ₙ. The first end disc 302₁ is disposed adjacent to the fluid connector 206 and the second end disc 302ₙ is disposed distal to the fluid connector 208. Each intermediate disc 302₂ to 302ₙ₋₁ is disposed between two adjacent annular discs 302.

At step 508, the inner diameter 214 of the first end disc 302₁ is connected to the fluid connector 206. At step 510, the inner diameter 214 of each intermediate disc 302₂ to 302ₙ₋₁ is connected to the inner diameter 214 of one adjacent annular disc 302. At step 512, the outer diameter 216 of each intermediate disc 302₂ to 302ₙ₋₁ is connected to the outer diameter 216 of the other adjacent annular disc 302. In some embodiments, each intermediate disc 302₂ to 302ₙ₋₁ is connected to the adjacent annular discs 302 by thermal sealing. At step 514, the outer diameter 216 of the second end disc 302ₙ is connected to the cover disc 306. In some embodiments, the second end disc 302ₙ is connected to the cover disc 306 by thermal sealing.

The method 500 may further include filling the housing 202 with the gas surrounding the plurality of annular discs 302 and the cover disc 306. The method 500 may further includes receiving, via the fluid connector 206, the hydraulic fluid within the first volume 402 defined by the plurality of annular discs302 and the cover disc 306.

The accumulator 200 may have low friction and provide adequate performance over a long period. The accumulator 200 may be lightweight and may involve low manufacturing cost. Further, generation of folding lines in the bag 300 may be substantially prevented due to the construction of the bag from the annular discs 302 and the cover disc 306. Therefore, deterioration of a material of the bag 300 and resultant leakage between the first volume 402 and the second volume 404 can be avoided.

The present disclosure explains application of the accumulator 200 with the monotube damper 120. However, the present disclosure can be readily implemented with any other type of damper, such as dual tube damper or a triple tube damper.

While aspects of the present disclosure have been particularly shown and described with reference to the embodiments above, it will be understood by those skilled in the art that various additional embodiments can be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An accumulator for a damper comprising:
a housing defining a longitudinal axis;
a fluid connector at least partially received within the housing; and
a bag comprising:
a plurality of annular discs received within the housing and disposed adjacent to each other along the longitudinal axis of the housing, each annular disc comprising an inner diameter defining a through aperture and an outer diameter, the plurality of annular discs comprising a first end disc disposed adjacent to the fluid connector, a second end disc disposed distal to the fluid connector and one or more intermediate discs, each intermediate disc being disposed between two adjacent annular discs, wherein the inner diameter of the first end disc is connected to the fluid connector, wherein the inner diameter of each intermediate disc is connected to the inner diameter of one adjacent annular disc, wherein the outer diameter of each intermediate disc is connected to the outer diameter of the other adjacent annular disc; and
a cover disc connected to the outer diameter of the second end disc, wherein the cover disc is a solid disc;
wherein the plurality of discs and the cover disc define a first volume therebetween, wherein the connector fluidly communicates the first volume with a chamber of the damper, and wherein the housing defines a second volume surrounding the bag.

2. The accumulator of claim 1, wherein each annular disc comprises a plurality of layers, the plurality of layer comprising at least one metallic layer and at least one polymeric layer.

3. The accumulator of claim 2, wherein the at least one metallic layer is disposed between two polymeric layers.

4. The accumulator of claim 1, wherein the cover disc comprises a plurality of layers, the plurality of layers comprising at least one metallic layer and at least one polymeric layer.

5. The accumulator of claim 4, wherein the at least one metallic layer is disposed between two polymeric layers.

6. The accumulator of claim 1, wherein the housing is made of a metallic material.

7. The accumulator of claim 1, wherein each intermediate disc is connected to the adjacent annular discs by thermal sealing.

8. The accumulator of claim 1, wherein the second end disc is connected to the cover disc by thermal sealing.

9. The accumulator of claim 1, wherein the first volume receives a hydraulic fluid therein from the damper, wherein the second volume receives a gas therein, and wherein the first volume is configured to change based on a direction of flow of the hydraulic fluid between the chamber of the damper and the first volume.

10. A damper comprising:
a tube defining a chamber therein, the chamber receiving a hydraulic fluid therein; and
an accumulator comprising:
a housing defining a longitudinal axis;
a fluid connector at least partially received within the housing; and
a bag comprising:
a plurality of annular discs received within the housing and disposed adjacent to each other along the longitudinal axis of the housing, each annular disc comprising an inner diameter defining a through aperture and an outer diameter, the plurality of annular discs comprising a first end disc disposed adjacent to the fluid connector, a second end disc disposed distal to the fluid connector and one or more intermediate discs, each intermediate disc being disposed between two adjacent annular discs, wherein the inner diameter of the first end disc is connected to the fluid connector, wherein the inner diameter of each intermediate disc is connected to the inner diameter of one adjacent annular disc, wherein the outer diameter of each intermediate disc is connected to the outer diameter of the other adjacent annular disc; and
a cover disc connected to the outer diameter of the second end disc, wherein the cover disc is a solid disc;
wherein the plurality of discs and the cover disc define a first volume therebetween, wherein the connector fluidly communicates the first volume with the chamber of the damper such that the first volume receives the hydraulic fluid therein, wherein the housing defines a second volume surrounding the bag and receiving a gas therein, and wherein the first volume is configured to change based on a direction of flow of the hydraulic fluid between the chamber of the damper and the first volume.

11. The damper of claim 10, wherein each annular disc comprises a plurality of layers, the plurality of layer comprising at least one metallic layer and at least one polymeric layer.

12. The damper of claim 11, wherein the at least one metallic layer is disposed between two polymeric layers.

13. The damper of claim 10, wherein the cover disc comprises a plurality of layers, the plurality of layers comprising at least one metallic layer and at least one polymeric layer.

14. The damper of claim 13, wherein the at least one metallic layer is disposed between two polymeric layers.

15. The damper of claim 10, wherein the housing is made of a metallic material.

16. A method of manufacturing an accumulator, the method comprising:
providing a housing defining a longitudinal axis;
receiving a fluid connector at least partially within the housing;
receiving a plurality of annular discs within the housing and disposed adjacent to each other along the longitudinal axis of the housing, each annular disc comprising an inner diameter defining a through aperture and an outer diameter, the plurality of annular discs comprising a first end disc disposed adjacent to the fluid connector, a second end disc disposed distal to the fluid connector and one or more intermediate discs, each intermediate disc being disposed between two adjacent annular discs;
connecting an inner diameter of the first end disc to the fluid connector;
connecting the inner diameter of each intermediate disc to the inner diameter of one adjacent annular disc;
connecting the outer diameter of each intermediate disc to the outer diameter of the other adjacent annular disc; and
connecting the outer diameter of the second end disc to a cover disc, wherein the cover disc is a solid disc.

17. The method of claim 16, further comprising filling the housing with a gas surrounding the plurality of annular discs and cover disc.

18. The method of claim 16, further comprising receiving, via the fluid connector, a hydraulic fluid within a first volume defined by the plurality of annular discs and the cover disc.

19. The method of claim 16, wherein each intermediate disc is connected to the adjacent annular discs by thermal sealing.

20. The method of claim 16, wherein the second end disc is connected to the cover disc by thermal sealing.

21. The method of claim 16, wherein receiving the fluid connector at least partially within the housing further comprises receiving the fluid connector at least partially through a wall of the housing.
